(19) United States
(12) Patent Application Publication
(10) Pub. No.: US 2026/0004407 A1
(43) Pub. Date: Jan. 1, 2026

(54) METHOD AND APPARATUSES FOR IMAGE PROCESSING

(71) Applicant: Beijing Zitiao Network Technology Co., Ltd., Beijing (CN)

(72) Inventor: Yang Bai, Beijing (CN)

(21) Appl. No.: 19/255,441

(22) Filed: Jun. 30, 2025

(30) Foreign Application Priority Data
Jul. 1, 2024 (CN) 202410874131.6

(51) Int. Cl. G06T 5/70; G06T 5/50; G06T 7/73

(52) U.S. Cl. CPC G06T 5/70; G06T 5/50; G06T 7/74; G06T 2207/20221

(57) ABSTRACT

Embodiments of the present application provide an image processing method and an apparatus, relating to a technical field of image processing. The method comprises: acquiring initial blurring parameters of a to-be-blurred image and adjustment parameters of each to-be-blurred pixel point in the to-be-blurred image, wherein the initial blurring parameters are parameters of a blurring algorithm for performing blurring processing on the to-be-blurred image; acquiring target blurring parameters of each to-be-blurred pixel point in the to-be-blurred image according to the initial blurring parameters and the adjustment parameters of each to-be-blurred pixel point in the to-be-blurred image; acquiring blurred pixel values of each to-be-blurred pixel point in the to-be-blurred image according to the target blurring parameters of each to-be-blurred pixel point in the to-be-blurred image; acquiring a blurred image corresponding to the to-be-blurred image according to the blurred pixel values of each to-be-blurred pixel point in the to-be-blurred image.

### CROSS-REFERENCE TO RELATED APPLICATION(S)

This application claims priority to Chinese Application No. 202410874131.6 filed in Jul. 1, 2024, the disclosures of which are incorporated herein by reference in their entireties.

### FIELD

The present application relates to a technical field of image processing, and particularly to an image processing method and an apparatus.

### BACKGROUND

Blurring processing on an image refers to the specific processing on the color values of pixels in the image to blur details and edges in the image to achieve effects of privacy protection, artistic creation and noise reducing.

### SUMMARY

In view of this, embodiments of the present application provide an image processing method and an apparatus.

In order to achieve the above-mentioned object, embodiments of the present application provide the following subject matter:

In a first aspect, the present application provides an image processing method comprising:
acquiring initial blurring parameters of a to-be-blurred image and adjustment parameters of each to-be-blurred pixel point in the to-be-blurred image, wherein the initial blurring parameters are parameters of a blurring algorithm for performing blurring processing on the to-be-blurred image;
acquiring target blurring parameters of each to-be-blurred pixel point in the to-be-blurred image according to the initial blurring parameters and the adjustment parameters of each to-be-blurred pixel point in the to-be-blurred image;
acquiring blurred pixel values of each to-be-blurred pixel point in the to-be-blurred image according to the target blurring parameters of each to-be-blurred pixel point in the to-be-blurred image;
acquiring a blurred image corresponding to the to-be-blurred image according to the blurred pixel values of each to-be-blurred pixel point in the to-be-blurred image.

Alternatively, one embodiment of the present application comprises: acquiring initial blurring parameters of a to-be-blurred image and adjustment parameters of each to-be-blurred pixel point in the to-be-blurred image, wherein the initial blurring parameters are parameters of a blurring algorithm for performing blurring processing on the to-be-blurred image;
acquiring target blurring parameters of each to-be-blurred pixel point in the to-be-blurred image according to the initial blurring parameters and the adjustment parameters of each to-be-blurred pixel point in the to-be-blurred image;
acquiring blurred pixel values of each to-be-blurred pixel point in the to-be-blurred image according to the target blurring parameters of each to-be-blurred pixel point in the to-be-blurred image;
acquiring a blurred image corresponding to the to-be-blurred image according to the blurred pixel values of each to-be-blurred pixel point in the to-be-blurred image.

Alternatively, one embodiment of the present application comprises: acquiring the adjustment parameters of each to-be-blurred pixel point in the to-be-blurred image comprising:
acquiring pixel coordinates of each to-be-blurred pixel point in the to-be-blurred image;
sampling in a feature map according to the pixel coordinates of each to-be-blurred pixel point in the to-be-blurred image respectively to acquire the adjustment parameters of each to-be-blurred pixel point in the to-be-blurred image.

Alternatively, one embodiment of the present application comprises: sampling in the feature map according to the pixel coordinates of each to-be-blurred pixel point in the to-be-blurred image respectively to acquire the adjustment parameters of each to-be-blurred pixel point in the to-be-blurred image comprises:
sampling in the feature map according to the pixel coordinates of each to-be-blurred pixel point in the to-be-blurred image respectively to acquire a first feature value of each to-be-blurred pixel point in the to-be-blurred image, wherein the first feature value comprises: at least one: of a color value, a brightness value, a color gradient value, or a brightness gradient value;
acquiring the adjustment parameters of each to-be-blurred pixel point in the to-be-blurred image according to the first feature value of each to-be-blurred pixel point in the to-be-blurred image respectively.

Alternatively, one embodiment of the present application comprises: acquiring the adjustment parameters of each to-be-blurred pixel point in the to-be-blurred image comprises:
acquiring pixel coordinates of each to-be-blurred pixel point in the to-be-blurred image;
substituting the pixel coordinates of each to-be-blurred pixel point in the to-be-blurred image into a preset spatial geometric relational expression respectively to acquire the adjustment parameters of each to-be-blurred pixel point in the to-be-blurred image.

Alternatively, one embodiment of the present application comprises: acquiring the adjustment parameters of each to-be-blurred pixel point in the to-be-blurred image comprises:
acquiring a second feature value of each to-be-blurred pixel point in the to-be-blurred image, wherein the second feature value comprises: at least one of: a color value, a brightness value, a color gradient value, or a brightness gradient value;
acquiring the adjustment parameters of each to-be-blurred pixel point in the to-be-blurred image according to the second feature value of each to-be-blurred pixel point in the to-be-blurred image respectively.

Alternatively, one embodiment of the present application comprises: acquiring the target blurring parameters of each to-be-blurred pixel point in the to-be-blurred image according to the initial blurring parameters and the adjustment parameters of each to-be-blurred pixel point in the to-be-blurred image comprises:
substituting the initial blurring parameters and adjustment parameters of a first pixel point in the to-be-blurred image into a preset formula to acquire target blurring parameters of the first pixel point;
wherein the first pixel point is any pixel point in the to-be-blurred image.

Alternatively, one embodiment of the present application comprises: after acquiring the blurred image corresponding to the to-be-blurred image according to the blurred pixel values of each to-be-blurred pixel point in the to-be-blurred image, the method further comprises:
superimposing and fusing the to-be-blurred image and the blurred image corresponding to the to-be-blurred image to acquire a target image corresponding to the to-be-blurred image.

In a second aspect, the present application provides an image processing apparatus comprising:
an acquisition unit, configured to acquire initial blurring parameters of a to-be-blurred image and adjustment parameters of each to-be-blurred pixel point in the to-be-blurred image, wherein the initial blurring parameters are parameters of a blurring algorithm for performing blurring processing on the to-be-blurred image;
a processing unit, configured to acquire target blurring parameters of each to-be-blurred pixel point in the to-be-blurred image according to the initial blurring parameters and the adjustment parameters of each to-be-blurred pixel point in the to-be-blurred image;
a blurring unit, configured to acquire blurred pixel values of each to-be-blurred pixel point in the to-be-blurred image according to the target blurring parameters of each to-be-blurred pixel point in the to-be-blurred image, and acquiring a blurred image corresponding to the to-be-blurred image according to the blurred pixel values of each to-be-blurred pixel point in the to-be-blurred image.

Alternatively, one embodiment of the present application comprises: the acquisition unit specifically for acquiring pixel coordinates of each to-be-blurred pixel point in the to-be-blurred image; sampling in a feature map according to the pixel coordinates of each to-be-blurred pixel point in the to-be-blurred image respectively to acquire the adjustment parameters of each to-be-blurred pixel point in the to-be-blurred image.

Alternatively, one embodiment of the present application comprises: the acquisition unit specifically for sampling in the feature map according to the pixel coordinates of each to-be-blurred pixel point in the to-be-blurred image respectively to acquire a first feature value of each to-be-blurred pixel point in the to-be-blurred image, wherein the first feature value comprises: at least one of: a color value, a brightness value, a color gradient value, or a brightness gradient value;
acquiring the adjustment parameters of each to-be-blurred pixel point in the to-be-blurred image according to the first feature value of each to-be-blurred pixel point in the to-be-blurred image respectively.

Alternatively, one embodiment of the present application comprises: the acquisition unit specifically for acquiring pixel coordinates of each to-be-blurred pixel point in the to-be-blurred image; substituting the pixel coordinates of each to-be-blurred pixel point in the to-be-blurred image into a preset spatial geometric relational expression respectively to acquire the adjustment parameters of each to-be-blurred pixel point in the to-be-blurred image.

Alternatively, one embodiment of the present application comprises: the acquisition unit specifically for acquiring a second feature value of each to-be-blurred pixel point in the to-be-blurred image, wherein the second feature value comprises: at least one of: a color value, a brightness value, a color gradient value, or a brightness gradient value; acquiring the adjustment parameters of each to-be-blurred pixel point in the to-be-blurred image according to the second feature value of each to-be-blurred pixel point in the to-be-blurred image respectively.

Alternatively, one embodiment of the present application comprises: the acquisition unit specifically for substituting the initial blurring parameters and adjustment parameters of a first pixel point in the to-be-blurred image into a preset formula to acquire target blurring parameters of the first pixel point;
wherein the first pixel point is any pixel point in the to-be-blurred image.

Alternatively, one embodiment of the present application comprises: the blurring unit specifically for superimposing and fusing the to-be-blurred image and the blurred image corresponding to the to-be-blurred image to acquire a target image corresponding to the to-be-blurred image.

In a third aspect, the present application provides an electronic device comprising: a memory for storing a computer program and a processor for causing, when the computer program is executed, the electronic device to implement the image processing method as claimed in any one of the above embodiments.

In a fourth aspect, the present application provides a computer-readable storage medium having stored thereon a computer program which, when executed by a computing device, causes the computing device to implement the image processing method as claimed in any one of the above embodiments.

In a fifth aspect, the present application provides a computer program product, when run on a computer, causing the computer to implement the image processing method as claimed in any one of the above embodiments.

The image processing method provided by an embodiment of the present application comprises: firstly acquiring initial blurring parameters of a to-be-blurred image and adjustment parameters of each to-be-blurred pixel point in the to-be-blurred image, then acquiring target blurring parameters of each to-be-blurred pixel point in the to-be-blurred image according to the initial blurring parameters and the adjustment parameters of each to-be-blurred pixel point in the to-be-blurred image, then acquiring blurred pixel values of each to-be-blurred pixel point in the to-be-blurred image according to the target blurring parameters of each to-be-blurred pixel point in the to-be-blurred image, and acquiring a blurred image corresponding to the to-be-blurred image according to the blurred pixel values of each to-be-blurred pixel point in the to-be-blurred image.

### BRIEF DESCRIPTION OF THE DRAWINGS

The figures are incorporated in and constitute a part of the description, showing embodiments consistent with the present application and, together with the description, serving to explain the principles of the present application.

In order to explain the embodiments of the present application or the technical solutions in the prior art more clearly, the following is a brief introduction to the figures which need to be called out in the depiction of the embodiments or the prior art. It would be obvious for a person skilled in the art to obtain other figures according to the figures herein without involving any inventive effort.

FIG. 1 is a first one of flowcharts illustrating steps of an image processing method according to an embodiment of the present application;

FIG. 2 is a second one of flowcharts illustrating steps of an image processing method according to an embodiment of the present application;

FIG. 3 is a third one of flowcharts illustrating steps of an image processing method according to an embodiment of the present application;

FIG. 4 is a fourth one of flowcharts illustrating steps of an image processing method according to an embodiment of the present application;

FIG. 5 is a schematic structural diagram of an image processing apparatus according to an embodiment of the present application;

FIG. 6 is a schematic structural diagram of an electronic device according to an embodiment of the present application.

### DETAILED DESCRIPTION OF EMBODIMENTS

In order that the above objects, features and advantages of the present application would be more clearly understood, the subject matter of the present application is further depicted. It is remarked that embodiments of the present application and features of the embodiments may be combined without conflict.

In the following depiction, numerous details are set forth in order to provide a thorough understanding of the present application. It is to be understood that the present application may be practiced otherwise than as specifically described herein. The embodiments in the depiction are only part of, but not all embodiments of the present application

In the present embodiments, the words “exemplary” or “for example” are used to serve as an example, instance, or illustration. Any embodiment or design described herein as “exemplary” or “for example” is not necessarily to be construed as preferred or advantageous over other embodiments or designs. Rather, invoking the word “exemplary” or “for example” is intended to present the relevant concepts in a specific manner. Further, in the depiction of the embodiments of the present application, the meaning of “a plurality” means two or more than two unless otherwise specified.

Blurring processing on an image refers to the specific processing on the color values of pixels in the image to blur details and edges in the image to achieve effects of privacy protection, artistic creation and noise reducing.

Currently, after finishing setting blurring parameters, mainstream image blurring tools apply the blurring parameters to various positions of a to-be-blurred image. When an image blurring operation is actually performed, there is often a need for different positions of the image to be processed using different blurring parameters. For example: when background out-of-focus blurring processing is performed on an image, the blurring intensity needs to be set to be smaller or even no blurring processing needs to be performed for the position with a smaller distance from the focal point, and the blurring intensity needs to be set to be larger for the position with a larger distance from the focal point. However, the existing image blurring tools cannot deal with different positions of the image using different blurring parameters.

In view of this, embodiments of the present application provide an image processing method and an apparatus, serving to deal with different positions of an image using different blurring parameters.

The image processing method provided by an embodiment of the present application comprises: firstly acquiring initial blurring parameters of a to-be-blurred image and adjustment parameters of each to-be-blurred pixel point in the to-be-blurred image, then acquiring target blurring parameters of each to-be-blurred pixel point in the to-be-blurred image according to the initial blurring parameters and the adjustment parameters of each to-be-blurred pixel point in the to-be-blurred image, then acquiring blurred pixel values of each to-be-blurred pixel point in the to-be-blurred image according to the target blurring parameters of each to-be-blurred pixel point in the to-be-blurred image, and acquiring a blurred image corresponding to the to-be-blurred image according to the blurred pixel values of each to-be-blurred pixel point in the to-be-blurred image. Since the image processing method provided in the embodiment of the present application can acquire adjustment parameters of each to-be-blurred pixel point in a to-be-blurred image, and acquire target blurring parameters of each to-be-blurred pixel point in the to-be-blurred image according to the initial blurring parameters and the adjustment parameters of each to-be-blurred pixel point in the to-be-blurred image, and then acquire blurred pixel values of each to-be-blurred pixel point in the to-be-blurred image according to the target blurring parameters of each to-be-blurred pixel point in the to-be-blurred image, and the to-be-blurred image has independent adjustment parameters, and therefore each to-be-blurred pixel point of a to-be-blurred image has different target blurring parameters. Thus, the embodiment of the present application can deal with different pixel points of an image using different blurring parameters.

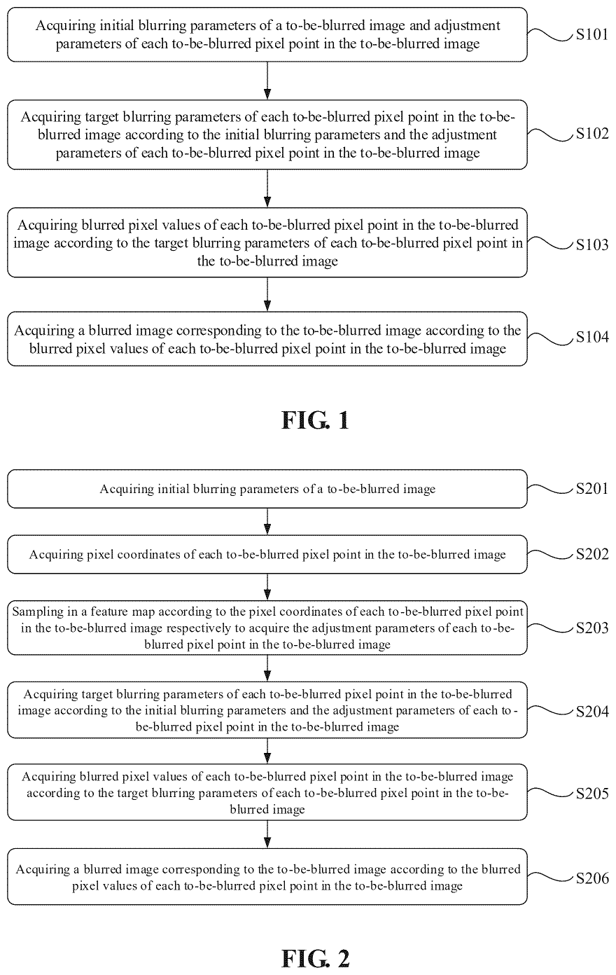

An embodiment of the present application provides an image processing method, and as shown with reference to FIG. 1, the image processing method comprises the following steps:

S101, acquiring initial blurring parameters of a to-be-blurred image and adjustment parameters of each to-be-blurred pixel point in the to-be-blurred image.

The initial blurring parameters are parameters of a blurring algorithm for performing blurring processing on the to-be-blurred image

In the embodiment of the present application, the initial blurring parameters may be all blurring parameters of a blurring algorithm used for performing blurring processing on the to-be-blurred image, or may be a part of a plurality of blurring parameters of the blurring algorithm used for performing blurring processing on the to-be-blurred image.

In some embodiments, the blurring algorithm performing blurring processing on the to-be-blurred image may be a Gaussian blurring algorithm and the initial blurring parameters may be a blurring degree or a blurring direction.

In some embodiments, the blurring algorithm performing blurring processing on the to-be-blurred image may be a directional blurring algorithm and the initial blurring parameters may be a blurring direction and/or a blur length.

In some embodiments, the blurring algorithm performing blurring processing on the to-be-blurred image may be a block blurring algorithm and the initial blurring parameters may be at least one of a blurring radius, a number of iterations, and a blurring direction.

In some embodiments, the blurring algorithm performing blurring processing on the to-be-blurred image may be a bi-directional blurring algorithm, and the initial blurring parameters may be at least one of a blurring radius, a number of iterations, and a blur threshold.

In some embodiments, the blurring algorithm performing blurring processing on the to-be-blurred image may be an intelligent blurring algorithm, and the initial blurring parameters may be at least one of a blurring radius, a blurring threshold, and a blurring pattern.

In some embodiments, the blurring algorithm performing blurring processing on the to-be-blurred image may be a radial blurring algorithm, and the initial blurring parameters may be at least one of a number of sample points, a radial blurring center, and a radial blurring type (zooming in or out).

In some embodiments, to-be-blurred pixel points in the to-be-blurred image may comprise all pixel points of the to-be-blurred image.

In some embodiments, the to-be-blurred pixel points in the to-be-blurred image may be pixel points within a specified area or pixel points within a specified object. For example: pixel points in a certain human face region are determined as the to-be-blurred pixel points.

In some embodiments, the to-be-blurred pixel points in the to-be-blurred image may be pixel points determined based on a preset algorithm. For example: the to-be-blurred pixel points in the to-be-blurred image can be pixel points selected by an image gradient algorithm and a color similarity algorithm.

S102, acquiring target blurring parameters of each to-be-blurred pixel point in the to-be-blurred image according to the initial blurring parameters and the adjustment parameters of each to-be-blurred pixel point in the to-be-blurred image.

In some embodiments, acquiring target blurring parameters of each to-be-blurred pixel point in the to-be-blurred image according to the initial blurring parameters and the adjustment parameters of each to-be-blurred pixel point in the to-be-blurred image comprises: substituting the initial blurring parameters and adjustment parameters of a first pixel point in the to-be-blurred image into a preset formula to acquire target blurring parameters of the first pixel point;
wherein the first pixel point is any pixel point in the to-be-blurred image.

Exemplary, the target blurring parameters of the first pixel point may be as follows:

$$c ( x , y ) = a * \frac{b ( x , y )}{max ( b )}$$

wherein c(x,y) is target blurring parameters of a first pixel point, a is initial blurring parameters of a to-be-blurred image, b(x,y) is adjustment parameters of the first pixel point, and max (b) is the maximum value of the adjustment parameters of each to-be-blurred pixel point.

S103, acquiring blurred pixel values of each to-be-blurred pixel point in the to-be-blurred image according to the target blurring parameters of each to-be-blurred pixel point in the to-be-blurred image.

That is, the initial blurring parameters are replaced with the target blurring parameters of each to-be-blurred pixel, and the blurred pixel values of each to-be-blurred pixel are calculated according to the replaced blurring algorithm.

It should be noted that the image processing method provided by the embodiments of the present application can adjust only one blurring parameter of the blurring algorithm and calculate blurring pixel values of each to-be-blurred pixel according to the adjusted blurring parameters, and can also adjust a plurality of blurring parameters of the blurring algorithm and then calculate blurring pixel values of each to-be-blurred pixel according to the adjusted blurring parameters, and when the plurality of blurring parameters of the blurring algorithm are adjusted, only the plurality of blurring parameters respectively need to be taken as initial blurring parameters, and the above-mentioned steps S101 and S102 are then executed.

S104, acquiring a blurred image corresponding to the to-be-blurred image according to the blurred pixel values of each to-be-blurred pixel point in the to-be-blurred image.

In some embodiments, the blurring pixel values of each to-be-blurred pixel in the to-be-blurred image may be taken as the pixel values of each to-be-blurred pixel in the to-be-blurred image to acquire a blurred image corresponding to the to-be-blurred image.

The image processing method provided by an embodiment of the present application comprises: firstly acquiring initial blurring parameters of a to-be-blurred image and adjustment parameters of each to-be-blurred pixel point in the to-be-blurred image, then acquiring target blurring parameters of each to-be-blurred pixel point in the to-be-blurred image according to the initial blurring parameters and the adjustment parameters of each to-be-blurred pixel point in the to-be-blurred image, then acquiring blurred pixel values of each to-be-blurred pixel point in the to-be-blurred image according to the target blurring parameters of each to-be-blurred pixel point in the to-be-blurred image, and acquiring a blurred image corresponding to the to-be-blurred image according to the blurred pixel values of each to-be-blurred pixel point in the to-be-blurred image. Since the image processing method provided in the embodiment of the present application can acquire adjustment parameters of each to-be-blurred pixel point in a to-be-blurred image, and acquire target blurring parameters of each to-be-blurred pixel point in the to-be-blurred image according to the initial blurring parameters and the adjustment parameters of each to-be-blurred pixel point in the to-be-blurred image, and then acquire blurred pixel values of each to-be-blurred pixel point in the to-be-blurred image according to the target blurring parameters of each to-be-blurred pixel point in the to-be-blurred image, and the to-be-blurred image has independent adjustment parameters, and therefore each to-be-blurred pixel point of a to-be-blurred image has different target blurring parameters. Thus, the embodiment of the present application can deal with different pixel points of an image using different blurring parameters.

As an extension and refinement to the above-mentioned embodiment, the embodiment of the present application also provides another image processing method which, as shown with reference to FIG. 2, comprises the following steps:

S201, acquiring initial blurring parameters of a to-be-blurred image.

The initial blurring parameters are parameters of a blurring algorithm for performing blurring processing on the to-be-blurred image.

S202, acquiring pixel coordinates of each to-be-blurred pixel point in the to-be-blurred image;

S203, sampling in a feature map according to the pixel coordinates of each to-be-blurred pixel point in the to-be-blurred image respectively to acquire the adjustment parameters of each to-be-blurred pixel point in the to-be-blurred image.

In some embodiments, the above-mentioned step S203 (sampling in the feature map according to the pixel coordinates of each to-be-blurred pixel point in the to-be-blurred image respectively to acquire the adjustment parameters of each to-be-blurred pixel point in the to-be-blurred image) comprises the following steps a to b:

Step a, sampling in the feature map according to the pixel coordinates of each to-be-blurred pixel point in the to-be-blurred image respectively to acquire a first feature value of each to-be-blurred pixel point in the to-be-blurred image.

The first feature value comprises: at least one of: a color value, a brightness value, a color gradient value, or a brightness gradient value.

Step b, acquiring the adjustment parameters of each to-be-blurred pixel point in the to-be-blurred image according to the first feature value of each to-be-blurred pixel point in the to-be-blurred image respectively.

Exemplary, when the first feature value is a brightness value and a brightness gradient value, acquiring the adjustment parameters of each to-be-blurred pixel point in the to-be-blurred image according to the first feature value of each to-be-blurred pixel point in the to-be-blurred image respectively comprises: acquiring pixel coordinates of each to-be-blurred pixel point in the to-be-blurred image according to the following formula:

$$b ( x , y ) = \frac{{G}_{Y} ( x , y ) * Y ( x , y )}{max ( {G}_{Y} ) * max ( Y )}$$

wherein b(x,y) is an adjustment parameter of a pixel point with a pixel coordinate (x,y), G_{Y}(x,y) is a brightness gradient value of a pixel point with a pixel coordinate (x,y), Y(x,y) is a brightness value of a pixel point with a pixel coordinate (x,y), max (G_{Y}) is a maximum value of brightness gradient values of each to-be-blurred pixel point, and max (Y) is a maximum value of brightness values of each to-be-blurred pixel point.

S204, acquiring target blurring parameters of each to-be-blurred pixel point in the to-be-blurred image according to the initial blurring parameters and the adjustment parameters of each to-be-blurred pixel point in the to-be-blurred image;

S205, acquiring blurred pixel values of each to-be-blurred pixel point in the to-be-blurred image according to the target blurring parameters of each to-be-blurred pixel point in the to-be-blurred image;

S206, acquiring a blurred image corresponding to the to-be-blurred image according to the blurred pixel values of each to-be-blurred pixel point in the to-be-blurred image.

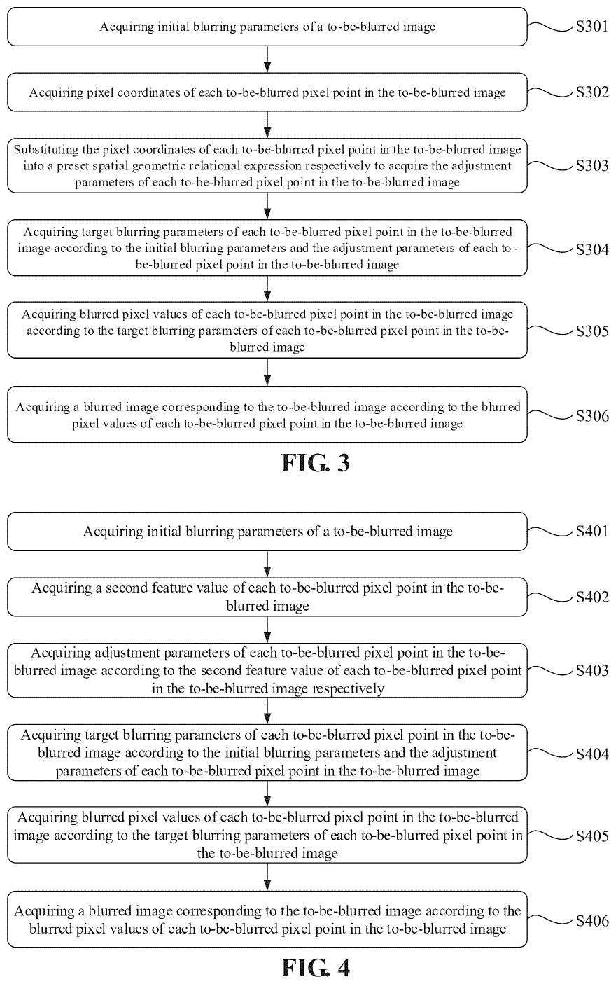

As an extension and refinement to the above-mentioned embodiment, the embodiment of the present application also provides another image processing method which, as shown with reference to FIG. 3, comprises the following steps:

S301, acquiring initial blurring parameters of a to-be-blurred image.

The initial blurring parameters are parameters of a blurring algorithm for performing blurring processing on the to-be-blurred image.

S302, acquiring pixel coordinates of each to-be-blurred pixel point in the to-be-blurred image.

S303, substituting the pixel coordinates of each to-be-blurred pixel point in the to-be-blurred image into a preset spatial geometric relational expression respectively to acquire the adjustment parameters of each to-be-blurred pixel point in the to-be-blurred image.

In some embodiments, substituting the pixel coordinates of each to-be-blurred pixel point in the to-be-blurred image into the preset spatial geometric relational expression respectively to acquire the adjustment parameters of each to-be-blurred pixel point in the to-be-blurred image comprises: substituting the pixel coordinates of each to-be-blurred pixel point in the to-be-blurred image into the following formula respectively so as to acquire the adjustment parameters of each to-be-blurred pixel point in the to-be-blurred image:

$$b ( x , y ) = \sqrt{{( x - {x}_{0} )}^{2} {( y - {y}_{0} )}^{2}}$$

wherein b(x,y) is an adjustment parameter of a pixel point with a pixel coordinate (x,y), x, y are an abscissa and an ordinate of the pixel point respectively, and x₀ and y₀ are constants representing a position coordinate of a geometric center.

S304, acquiring target blurring parameters of each to-be-blurred pixel point in the to-be-blurred image according to the initial blurring parameters and the adjustment parameters of each to-be-blurred pixel point in the to-be-blurred image.

S305, acquiring blurred pixel values of each to-be-blurred pixel point in the to-be-blurred image according to the target blurring parameters of each to-be-blurred pixel point in the to-be-blurred image.

S306, acquiring a blurred image corresponding to the to-be-blurred image according to the blurred pixel values of each to-be-blurred pixel point in the to-be-blurred image.

As an extension and refinement to the above-mentioned embodiment, the embodiment of the present application also provides another image processing method which, as shown with reference to FIG. 4, comprises the following steps:

S401, acquiring initial blurring parameters of a to-be-blurred image.

The initial blurring parameters are parameters of a blurring algorithm for performing blurring processing on the to-be-blurred image.

S402, acquiring a second feature value of each to-be-blurred pixel point in the to-be-blurred image.

The second feature value comprises at least one of: a color value, a brightness value, a color gradient value, or a brightness gradient value.

S403, acquiring the adjustment parameters of each to-be-blurred pixel point in the to-be-blurred image according to the second feature value of each to-be-blurred pixel point in the to-be-blurred image respectively.

Exemplary, when the second feature value is a color value and a brightness value, acquiring the adjustment parameters of each to-be-blurred pixel point in the to-be-blurred image according to the second feature value of each to-be-blurred pixel point in the to-be-blurred image respectively comprises: acquiring the adjustment parameters of each to-be-blurred pixel point in the to-be-blurred image according to the following formula:

$$b ( x , y ) = \frac{I ( x , y ) + Y ( x , y )}{max ( I ) + max ( Y )}$$

wherein b(x,y) is an adjustment parameter of a pixel point with a pixel coordinate (x,y), I(x,y) is a color gradient value of a pixel point with a pixel coordinate (x,y), Y(x,y) is a brightness value of a pixel point with a pixel coordinate (x,y), max (I) is a maximum value of color values of each to-be-blurred pixel point, and max (Y) is a maximum value of color values of each to-be-blurred pixel point.

S404, acquiring target blurring parameters of each to-be-blurred pixel point in the to-be-blurred image according to the initial blurring parameters and the adjustment parameters of each to-be-blurred pixel point in the to-be-blurred image.

S405, acquiring blurred pixel values of each to-be-blurred pixel point in the to-be-blurred image according to the target blurring parameters of each to-be-blurred pixel point in the to-be-blurred image.

S406, acquiring a blurred image corresponding to the to-be-blurred image according to the blurred pixel values of each to-be-blurred pixel point in the to-be-blurred image.

In some embodiments, after any one of the above-mentioned embodiments is provided to acquire a blurred image corresponding to a to-be-blurred image, the image processing method provided by an embodiment of the present application further comprises:

superimposing and fusing the to-be-blurred image and the blurred image corresponding to the to-be-blurred image to acquire a target image corresponding to the to-be-blurred image.

Exemplary, superimposing and fusing the blurred image corresponding to the to-be-blurred image and the to-be-blurred image to acquire a target image corresponding to the to-be-blurred image may comprise: weighting pixel values of pixel points with the same pixel coordinates in the blurred image and the to-be-blurred image according to preset weights to acquire a target image corresponding to the to-be-blurred image.

Based on the same inventive concept, an embodiment of the present application further provides an image processing apparatus as an implementation of the above-mentioned method, and this embodiment corresponds to the above-mentioned method embodiment. For the convenience of reading, this embodiment will not repeat the details of the above-mentioned method embodiment one by one, but it should be clear that the image processing apparatus in this embodiment can correspondingly implement all the contents of the above-mentioned method embodiment.

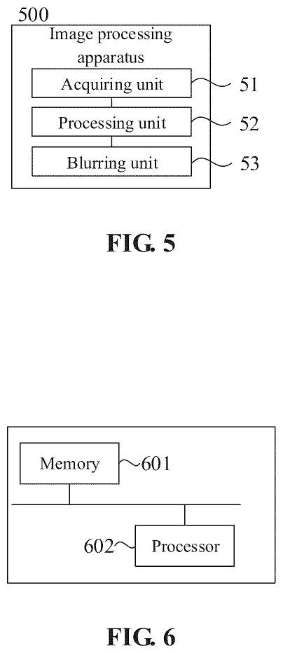

An embodiment of the present application provides an image processing apparatus, and FIG. 5 is a schematic structural diagram of the image processing apparatus. As shown in FIG. 5, an image processing apparatus 500 comprises:
An acquisition unit 51 for acquiring initial blurring parameters of a to-be-blurred image and adjustment parameters of each to-be-blurred pixel point in the to-be-blurred image, wherein the initial blurring parameters are parameters of a blurring algorithm for performing blurring processing on the to-be-blurred image;
A processing unit 52 for acquiring target blurring parameters of each to-be-blurred pixel point in the to-be-blurred image according to the initial blurring parameters and the adjustment parameters of each to-be-blurred pixel point in the to-be-blurred image;
And a blurring unit 53 for acquiring blurred pixel values of each to-be-blurred pixel point in the to-be-blurred image according to the target blurring parameters of each to-be-blurred pixel point in the to-be-blurred image, and acquiring a blurred image corresponding to the to-be-blurred image according to the blurred pixel values of each to-be-blurred pixel point in the to-be-blurred image.

As an alternative embodiment of an embodiment of the present application, the acquisition unit 51 is specifically used for acquiring pixel coordinates of each to-be-blurred pixel point in the to-be-blurred image; sampling in a feature map according to the pixel coordinates of each to-be-blurred pixel point in the to-be-blurred image respectively to acquire the adjustment parameters of each to-be-blurred pixel point in the to-be-blurred image.

As an alternative embodiment of an embodiment of the present application, the acquisition unit 51 is specifically used for sampling in the feature map according to the pixel coordinates of each to-be-blurred pixel point in the to-be-blurred image respectively to acquire a first feature value of each to-be-blurred pixel point in the to-be-blurred image, wherein the first feature value comprises: at least one of a color value, a luminance value, a color gradient value, and a luminance gradient value;
acquiring the adjustment parameters of each to-be-blurred pixel point in the to-be-blurred image according to the first feature value of each to-be-blurred pixel point in the to-be-blurred image respectively.

As an alternative embodiment of an embodiment of the present application, the acquisition unit 51 is specifically used for acquiring pixel coordinates of each to-be-blurred pixel point in the to-be-blurred image; substituting the pixel coordinates of each to-be-blurred pixel point in the to-be-blurred image into a preset spatial geometric relational expression respectively to acquire the adjustment parameters of each to-be-blurred pixel point in the to-be-blurred image.

As an alternative embodiment of an embodiment of the present application, the acquisition unit 51 is specifically used for acquiring a second feature value of each to-be-blurred pixel point in the to-be-blurred image; the second feature value comprising: at least one of a color value, a luminance value, a color gradient value, and a luminance gradient value; acquiring the adjustment parameters of each to-be-blurred pixel point in the to-be-blurred image according to the second feature value of each to-be-blurred pixel point in the to-be-blurred image respectively.

As an alternative embodiment of an embodiment of the present application, the acquisition unit 51 is specifically used for substituting the initial blurring parameters and adjustment parameters of a first pixel point in the to-be-blurred image into a preset formula to acquire target blurring parameters of the first pixel point;
wherein the first pixel point is any pixel point in the to-be-blurred image.

As an alternative embodiment of the embodiment of the present application, the blurring unit 53 is also used for superimposing and fusing the to-be-blurred image and the blurred image corresponding to the to-be-blurred image to acquire a target image corresponding to the to-be-blurred image.

The image processing apparatus provided by an embodiment of the present application can execute the image processing method provided by any of the above-mentioned embodiments, and the implementation principle thereof is similar to the technical effect, and would not be described in detail herein.

Based on the same inventive concept, an embodiment of the present application also provides an electronic device. FIG. 6 is a schematic structure diagram of an electronic device according to an embodiment of the present application. As shown in FIG. 6, the electronic device provided in the embodiment comprises: a memory 601 for storing a computer program and a processor 602 for executing the image processing method provided by the above-mentioned when the computer program is executed.

Based on the same inventive concept, embodiments of the present application also provide a computer-readable storage medium having stored thereon a computer program which, when executed by a processor, causes the computing device to implement the image processing method provided by the above embodiments.

Based on the same inventive concept, embodiments of the present application also provide a computer program product which, when run on a computer, causes the computing device to implement the image processing method provided by the embodiments described above.

As will be appreciated by one of skill in the art, embodiments of the present application may be provided as a method, a system, or a computer program product. Accordingly, the present application may take the form of an entirely hardware embodiment, an entirely software embodiment or an embodiment combining software and hardware. Moreover, the present application may take the form of a computer program product embodied in one or more computer-usable storage media having computer-usable program code embodied therein.

The processor may be a Central Processing Unit (CPU), but may also be other general purpose processors, a Digital Signal Processor (DSP), an Application Specific Integrated Circuit (ASIC), a Field-Programmable Gate Array (FPGA) or other programmable logic device, a discrete gate or transistor logic device, discrete hardware components, etc. A general-purpose processor may be a microprocessor, but in the alternative, the processor may be any conventional processor.

The memory may include forms of non-persistent memory, random access memory (RAM), and/or non-volatile memory such as read only memory (ROM) or flash RAM in a computer-readable medium. The memory is an example of a computer-readable medium.

The computer-readable media includes both permanent and non-permanent, removable and non-removable storage media. The storage medium may implement the storage of information by any method or technology, and the information may be computer-readable instructions, data structures, modules of a program, or other data. Examples of storage media for a computer include, but are not limited to, phase change memory (PRAM), static random access memory (SRAM), dynamic random access memory (DRAM), other types of random access memory (RAM), read only memory (ROM), electrically erasable programmable read only memory (EEPROM), flash memory or other memory technology, compact disk read only memory (CD-ROM), digital versatile disks (DVD) or other optical storage, magnetic cassettes, magnetic disk storage or other magnetic storage devices, or any other non-transmission media that can be used to store information that can be accessed by a computing device. As defined herein, a computer-readable medium does not include transitory media, such as modulated data signals and carrier waves.

At last, it should be noted that the above-mentioned embodiments are merely illustrative of the technical solutions of the present application, and are not restrictive. Although the present application has been described in detail with reference to the above-mentioned embodiments, a person of ordinary skill in the art would have been able to make modifications to the technical solutions described in the above-mentioned embodiments, or make equivalent substitutions for some or all of the technical features thereof, without departing from the scope of the technical solutions of the embodiments of the present application in nature.

I/We claim:

1. An image processing method comprising:
acquiring initial blurring parameters of a to-be-blurred image and adjustment parameters of each to-be-blurred pixel point in the to-be-blurred image, wherein the initial blurring parameters are parameters of a blurring algorithm for performing blurring processing on the to-be-blurred image;
acquiring target blurring parameters of each to-be-blurred pixel point in the to-be-blurred image according to the initial blurring parameters and the adjustment parameters of each to-be-blurred pixel point in the to-be-blurred image;
acquiring blurred pixel values of each to-be-blurred pixel point in the to-be-blurred image according to the target blurring parameters of each to-be-blurred pixel point in the to-be-blurred image; and
acquiring a blurred image corresponding to the to-be-blurred image according to the blurred pixel values of each to-be-blurred pixel point in the to-be-blurred image.

2. The method according to claim 1, wherein acquiring the adjustment parameters of each to-be-blurred pixel point in the to-be-blurred image comprises:
acquiring pixel coordinates of each to-be-blurred pixel point in the to-be-blurred image; and
sampling in a feature map according to the pixel coordinates of each to-be-blurred pixel point in the to-be-blurred image respectively to acquire the adjustment parameters of each to-be-blurred pixel point in the to-be-blurred image.

3. The method according to claim 2, wherein sampling in the feature map according to the pixel coordinates of each to-be-blurred pixel point in the to-be-blurred image respectively to acquire the adjustment parameters of each to-be-blurred pixel point in the to-be-blurred image comprises:
sampling in the feature map according to the pixel coordinates of each to-be-blurred pixel point in the to-be-blurred image respectively to acquire a first feature value of each to-be-blurred pixel point in the to-be-blurred image, wherein the first feature value comprises: at least one of: a color value, a brightness value, a color gradient value, or a brightness gradient value; and
acquiring the adjustment parameters of each to-be-blurred pixel point in the to-be-blurred image according to the first feature value of each to-be-blurred pixel point in the to-be-blurred image respectively.

4. The method according to claim 1, wherein acquiring the adjustment parameters of each to-be-blurred pixel point in the to-be-blurred image comprises:
acquiring pixel coordinates of each to-be-blurred pixel point in the to-be-blurred image; and
substituting the pixel coordinates of each to-be-blurred pixel point in the to-be-blurred image into a preset spatial geometric relational expression respectively to acquire the adjustment parameters of each to-be-blurred pixel point in the to-be-blurred image.

5. The method according to claim 1, wherein acquiring the adjustment parameters of each to-be-blurred pixel point in the to-be-blurred image comprises:
acquiring a second feature value of each to-be-blurred pixel point in the to-be-blurred image, wherein the second feature value comprises: at least one of: a color value, a brightness value, a color gradient value, or a brightness gradient value; and
acquiring the adjustment parameters of each to-be-blurred pixel point in the to-be-blurred image according to the second feature value of each to-be-blurred pixel point in the to-be-blurred image respectively.

6. The method according to claim 1, wherein acquiring the target blurring parameters of each to-be-blurred pixel point in the to-be-blurred image according to the initial blurring parameters and the adjustment parameters of each to-be-blurred pixel point in the to-be-blurred image comprises:
substituting the initial blurring parameters and adjustment parameters of a first pixel point in the to-be-blurred image into a preset formula to acquire target blurring parameters of the first pixel point;
wherein the first pixel point is any pixel point in the to-be-blurred image.

7. The method according to claim 1, wherein after acquiring the blurred image corresponding to the to-be-blurred image according to the blurred pixel values of each to-be-blurred pixel point in the to-be-blurred image, the method further comprises:
superimposing and fusing the to-be-blurred image and the blurred image corresponding to the to-be-blurred image to acquire a target image corresponding to the to-be-blurred image.

8. An electronic device comprising: a memory and a processer, wherein the memory is configured to store a computer program, and the processor is configured to, when executing the computer program, cause the electronic device to implement an image processing method comprising:
acquiring initial blurring parameters of a to-be-blurred image and adjustment parameters of each to-be-blurred pixel point in the to-be-blurred image, wherein the initial blurring parameters are parameters of a blurring algorithm for performing blurring processing on the to-be-blurred image;
acquiring target blurring parameters of each to-be-blurred pixel point in the to-be-blurred image according to the initial blurring parameters and the adjustment parameters of each to-be-blurred pixel point in the to-be-blurred image;
acquiring blurred pixel values of each to-be-blurred pixel point in the to-be-blurred image according to the target blurring parameters of each to-be-blurred pixel point in the to-be-blurred image; and
acquiring a blurred image corresponding to the to-be-blurred image according to the blurred pixel values of each to-be-blurred pixel point in the to-be-blurred image.

9. The electronic device according to claim 8, wherein acquiring the adjustment parameters of each to-be-blurred pixel point in the to-be-blurred image comprises:
acquiring pixel coordinates of each to-be-blurred pixel point in the to-be-blurred image; and
sampling in a feature map according to the pixel coordinates of each to-be-blurred pixel point in the to-be-blurred image respectively to acquire the adjustment parameters of each to-be-blurred pixel point in the to-be-blurred image.

10. The electronic device according to claim 9, wherein sampling in the feature map according to the pixel coordinates of each to-be-blurred pixel point in the to-be-blurred image respectively to acquire the adjustment parameters of each to-be-blurred pixel point in the to-be-blurred image comprises:
sampling in the feature map according to the pixel coordinates of each to-be-blurred pixel point in the to-be-blurred image respectively to acquire a first feature value of each to-be-blurred pixel point in the to-be-blurred image, wherein the first feature value comprises: at least one of: a color value, a brightness value, a color gradient value, or a brightness gradient value; and
acquiring the adjustment parameters of each to-be-blurred pixel point in the to-be-blurred image according to the first feature value of each to-be-blurred pixel point in the to-be-blurred image respectively.

11. The electronic device according to claim 8, wherein acquiring the adjustment parameters of each to-be-blurred pixel point in the to-be-blurred image comprises:
acquiring pixel coordinates of each to-be-blurred pixel point in the to-be-blurred image; and
substituting the pixel coordinates of each to-be-blurred pixel point in the to-be-blurred image into a preset spatial geometric relational expression respectively to acquire the adjustment parameters of each to-be-blurred pixel point in the to-be-blurred image.

12. The electronic device according to claim 8, wherein acquiring the adjustment parameters of each to-be-blurred pixel point in the to-be-blurred image comprises:
acquiring a second feature value of each to-be-blurred pixel point in the to-be-blurred image, wherein the second feature value comprises: at least one of: a color value, a brightness value, a color gradient value, or a brightness gradient value; and
acquiring the adjustment parameters of each to-be-blurred pixel point in the to-be-blurred image according to the second feature value of each to-be-blurred pixel point in the to-be-blurred image respectively.

13. The electronic device according to claim 8, wherein acquiring the target blurring parameters of each to-be-blurred pixel point in the to-be-blurred image according to the initial blurring parameters and the adjustment parameters of each to-be-blurred pixel point in the to-be-blurred image comprises:
substituting the initial blurring parameters and adjustment parameters of a first pixel point in the to-be-blurred image into a preset formula to acquire target blurring parameters of the first pixel point;
wherein the first pixel point is any pixel point in the to-be-blurred image.

14. The electronic device according to claim 8, wherein after acquiring the blurred image corresponding to the to-be-blurred image according to the blurred pixel values of each to-be-blurred pixel point in the to-be-blurred image, the method further comprises:
superimposing and fusing the to-be-blurred image and the blurred image corresponding to the to-be-blurred image to acquire a target image corresponding to the to-be-blurred image.

15. A non-transitory computer-readable storage medium having stored thereon a computer program which, when executed by a computing device, causes the computing device to implement an image processing method comprising:
acquiring initial blurring parameters of a to-be-blurred image and adjustment parameters of each to-be-blurred pixel point in the to-be-blurred image, wherein the initial blurring parameters are parameters of a blurring algorithm for performing blurring processing on the to-be-blurred image;
acquiring target blurring parameters of each to-be-blurred pixel point in the to-be-blurred image according to the initial blurring parameters and the adjustment parameters of each to-be-blurred pixel point in the to-be-blurred image;
acquiring blurred pixel values of each to-be-blurred pixel point in the to-be-blurred image according to the target blurring parameters of each to-be-blurred pixel point in the to-be-blurred image; and
acquiring a blurred image corresponding to the to-be-blurred image according to the blurred pixel values of each to-be-blurred pixel point in the to-be-blurred image.

16. The non-transitory computer-readable storage medium according to claim 15, wherein acquiring the adjustment parameters of each to-be-blurred pixel point in the to-be-blurred image comprises:
acquiring pixel coordinates of each to-be-blurred pixel point in the to-be-blurred image; and
sampling in a feature map according to the pixel coordinates of each to-be-blurred pixel point in the to-be-blurred image respectively to acquire the adjustment parameters of each to-be-blurred pixel point in the to-be-blurred image.

17. The non-transitory computer-readable storage medium according to claim 16, wherein sampling in the feature map according to the pixel coordinates of each to-be-blurred pixel point in the to-be-blurred image respectively to acquire the adjustment parameters of each to-be-blurred pixel point in the to-be-blurred image comprises:
sampling in the feature map according to the pixel coordinates of each to-be-blurred pixel point in the to-be-blurred image respectively to acquire a first feature value of each to-be-blurred pixel point in the to-be-blurred image, wherein the first feature value comprises: at least one of: a color value, a brightness value, a color gradient value, or a brightness gradient value; and
acquiring the adjustment parameters of each to-be-blurred pixel point in the to-be-blurred image according to the first feature value of each to-be-blurred pixel point in the to-be-blurred image respectively.

18. The non-transitory computer-readable storage medium according to claim 15, wherein acquiring the adjustment parameters of each to-be-blurred pixel point in the to-be-blurred image comprises:
acquiring pixel coordinates of each to-be-blurred pixel point in the to-be-blurred image; and
substituting the pixel coordinates of each to-be-blurred pixel point in the to-be-blurred image into a preset spatial geometric relational expression respectively to acquire the adjustment parameters of each to-be-blurred pixel point in the to-be-blurred image.

19. The non-transitory computer-readable storage medium according to claim 15, wherein acquiring the adjustment parameters of each to-be-blurred pixel point in the to-be-blurred image comprises:
acquiring a second feature value of each to-be-blurred pixel point in the to-be-blurred image, wherein the second feature value comprises: at least one of: a color value, a brightness value, a color gradient value, or a brightness gradient value; and
acquiring the adjustment parameters of each to-be-blurred pixel point in the to-be-blurred image according to the second feature value of each to-be-blurred pixel point in the to-be-blurred image respectively.

20. The non-transitory computer-readable storage medium according to claim 15, wherein acquiring the target blurring parameters of each to-be-blurred pixel point in the to-be-blurred image according to the initial blurring parameters and the adjustment parameters of each to-be-blurred pixel point in the to-be-blurred image comprises:
substituting the initial blurring parameters and adjustment parameters of a first pixel point in the to-be-blurred image into a preset formula to acquire target blurring parameters of the first pixel point;
wherein the first pixel point is any pixel point in the to-be-blurred image.
